(19) United States
(12) Patent Application Publication
(10) Pub. No.: US 2015/0019404 A1
(43) Pub. Date: Jan. 15, 2015

(54) CREDITWORTHINESS DETERMINATION THROUGH ONLINE SOCIAL NETWORK ENDORSEMENTS

(71) Applicant: TollShare, Inc., Danville, CA (US)

(72) Inventors: Murali M. Karamchedu, Portland, OR (US); Ravi Asnani, Los Angeles, CA (US); Sanjay Nambiar, Los Angeles, CA (US)

(73) Assignee: TollShare, Inc., Danville, CA (US)

(21) Appl. No.: 13/942,154

(22) Filed: Jul. 15, 2013

(51) Int. Cl. G06Q 40/02; G06Q 50/00

(52) U.S. Cl. CPC G06Q 40/025; G06Q 50/01
USPC 705/38

(57) ABSTRACT

Embodiments relate to computer-implemented methods and computing apparatuses for technologically determining a creditworthiness metric for a potential borrower are disclosed. In embodiments, a creditworthiness metric for a potential borrower may be determined based at least in part on endorsements of other parties connected to the potential borrowers via an online social network. In embodiments, users of an online social network may make respective endorsements of other users of the online social network. Respective creditworthiness metrics may be determined based on the endorsements, and/or other factors, such as connections, endorsement values, so forth. Other embodiments may be disclosed and/or claimed.

### BACKGROUND

Existing credit scores denoting credit worthiness of individuals are usually based on past actions of the individuals. For example, the credit score of an individual may be based on factors such as how often the individual has purchased an item in the past using credit, either through a loan, a mortgage, a credit card, or some other credit vehicles. Additionally, the credit score may be based on how timely the individual has been in re-paying one or more past loans, e.g. whether the individual paid the loan back on time, late, or defaulted on the loan. Technology has been employed to assist in determining an individual's creditworthiness based on the individual's past behaviors, mainly in assisting in the processing the volume of data.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

FIG. 1 illustrates an example of a creditworthiness assessment online social network, in accordance with various embodiments.

FIG. 2 illustrates an example of a credit endorsement weighting process, in accordance with various embodiments.

FIG. 3 illustrates an example of a process for calculating a creditworthiness metric based on weighted credit endorsements, in accordance with various embodiments.

FIG. 4 illustrates an example index of weighting factors used in a creditworthiness metric calculation, in accordance with various embodiments.

FIG. 5 illustrates an example of a computing environment suitable for practicing the disclosure, in accordance with various embodiments.

### DETAILED DESCRIPTION

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

As described above, existing credit scores or credit factor calculations may be based on past actions or credit histories of a user. For example, the calculations may be based on how timely or thorough a user has been in repaying a past loan, how many loans or lines of credit the user has received, or other factors. However, in many cases this credit calculation may only be based on past actions of the user, and not take into account the current behaviors or actions of a user. For example, if an individual has been very good at repaying credit in the past, but is currently experiencing personal or financial problems, then the individual may receive a credit score that inaccurately inflates the individual's creditworthiness. Similarly, if the individual has experienced significant personal or financial problems in the past which have since been resolved, the individual may receive an inaccurately low credit score.

One way to resolve this potential inaccuracy may be to use the individual's current circumstances in a credit calculation. One way to use the individual's current circumstances may be to base a credit calculation on endorsements of the individual by people that currently know and interact with the individual. Embodiments of the present disclosure provide for ways to accomplish this sort of credit calculation or decision by basing a creditworthiness metric of an individual, hereinafter called an “endorsee,” on endorsements by people that know the individual, hereinafter called “endorsers,” in a social network.

An endorsement weighting module may receive an endorsement by an endorser of an endorsee. The endorsement weighting module may identify an endorser weighting factor of the endorser based on a number of factors such as a connection weighting factor describing the strength of the connection between the endorser/endorsee, and an endorsement value weighting factor describing how successful the endorser has been in making past endorsements. The endorser weighting factor may be supplied to a credit assessor module which may be configured to calculate a creditworthiness metric of the endorsee based at least in part on the endorser weighting factor. The credit assessor module may be able to use multiple endorsements, and therefore multiple endorser weighting factor(s) in calculating the creditworthiness metric. In some embodiments, the credit assessor module may supply the creditworthiness metric to other entities such as a financial institution that is able to use the creditworthiness metric in determining whether to extend a line of credit to the endorsee.

In other words, embodiments of present disclosure include computer-implemented methods and computing apparatuses for technologically determining a creditworthiness metric for a potential borrower. Embodiments of the present disclosure enable creditworthiness of an individual to be determined not only based on the individual's past behaviors that may be indicative of creditworthiness, but further based on endorsements of an individual can garner from the online world, where increasingly more and more potential borrowers are part of, and actively interact with one another.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrase “A and/or B” means (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

As used herein, the term “module” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

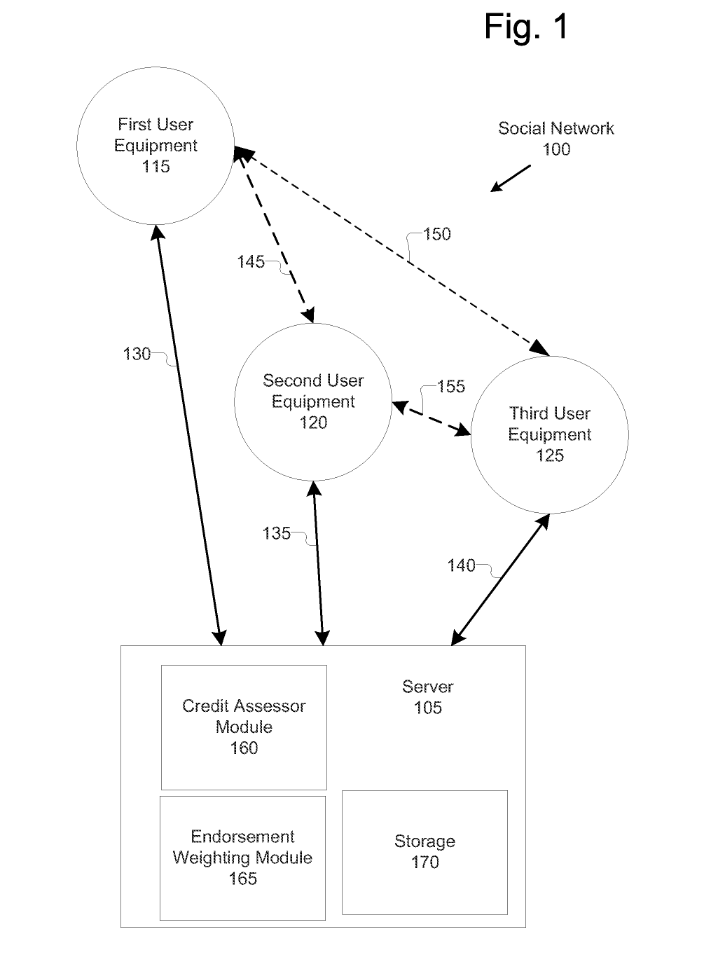

FIG. 1 depicts an example of a creditworthiness assessment online social network 100 in accordance with embodiments. The online social network 100 may be implemented by a server 105. Although the server 105 is illustrated in FIG. 1 as a single entity, in some embodiments the server 105 may comprise multiple hardware or software elements which are networked or otherwise coupled to one another such that data may be transmitted and received to and from each other. For example, in some embodiments the server 105 may comprise a group or cluster of servers, i.e. a “server farm.” Further, hereinafter “online social network 100” may simply be referred to as “social network 100.”

The server 105 may be coupled with one or more user equipment such as first user equipment 115, second user equipment 120, and third user equipment 125. First, second, and third user equipment 115, 120, and 125 may respectively be used by or correspond to user accounts of first, second, and third users. In embodiments, a user may be a person, group of people, company, or some other type of user. The server 105 may be respectively coupled to the first, second, and third user equipment 115, 120, and 125 via communication links 130, 135, and 140. In some embodiments the first, second, and third user equipment 115, 120, and 125 may be cellular phones, smartphones, tablet computers, desktop computers, laptop computers, personal digital assistants (PDAs), or some other form of computing device usable by the first, second, or third users. In embodiments, the first, second, and third user equipment 115, 120, and 125 may be operable to communicate directly with one another, for example by communication links 145, 150, and 155. In other embodiments the first, second, and third user equipment 115, 120, and 125 may not be operable to communicate with one another. In other embodiments, the first, second, and third user equipment 115, 120, and 125 may be operable to communicate with one another via the server 105. For example, first user equipment 115 may transmit a message via communication link 130 to the server 105, and the server 105 may then route the message to the third user equipment 125 via communication link 140.

In embodiments, the communication links 130, 135, 140, 145, 150, or 155 may be wired or wireless. For example, communication links 130, 135, 140, 145, 150, or 155 may be configured to transmit data between the server 105 and the user equipment 115, 120, or 125, or between the user equipment 115, 120, or 125, over a wired network such as a public switched telephone network (PSTN), a circuit switched network, an Ethernet connection, a USB connection, a firewire connection, or some other wired connection. Alternatively, the communication links 130, 135, 140, 145, 150, or 155 may be wireless and involve a wireless connection such as an institute of electrical and electronics engineers (IEEE) 802.11 specified WiFi connection, an IEEE 802.16 specified Worldwide Interoperability for Microwave Access (WiMAX) connection, a third generation partnership project (3GPP) network such as a universal mobile telecommunications system (UMTS) connection, a long term evolution (LTE) connection, or some other wireless connection such as any other 2G/3G/4G/4.5G/5G connection known or hereafter developed. In some embodiments, one or more of the communication links 130, 135, 140, 145, 150, or 155 may be a combination of two or more of the above listed network types.

In embodiments, the server 105 may include one or both of a credit assessor module 160 or an endorsement weighting module 165, as explained in further detail below. In embodiments, the credit assessor module 160 and endorsement weighting module 165 may be implemented in any combination of hardware and/or software. In embodiments, the combination of hardware and/or software may include processor(s), memory and executable instructions implementing the functions described herein. In embodiments, in lieu of being two separate modules, credit assessor module 160 and endorsement weighting module 165 may share some common functions and/or resources. For example, credit assessor module 160 and endorsement weighting module 165 may share common communication functions and components for communicating with first, second, or third user equipment 115, 120, or 125 and providers of online information. As a further example, credit assessor module 160 and endorsement weighting module 165 may share processor and/or memory resources. In embodiments, some functions of credit assessor module 160 may be moved to endorsement weighting module 165, or vice versa, or be combined.

In other embodiments, the credit assessor module 160 and the endorsement weighting module 165 may be on different servers, or operated by different entities. For example, the social network 100 may only include a server with the endorsement weighting module 165 which is operable to weight endorsements of an endorsee, as explained in further detail below. The weighted endorsements may then be supplied to a credit assessor module operated by a financial or business entity such as a credit rating agency, a bank, a loan institution, a credit card company, a B2B business entity or some other entity. The financial or business entity may include a server such as server 105 (not shown) with a credit assessor module such as credit assessor module 160.

In embodiments, storage 170 may be any one of a number of non-volatile magnetic, optic, and/or solid state storage. Storage 170 may further include one or more caches.

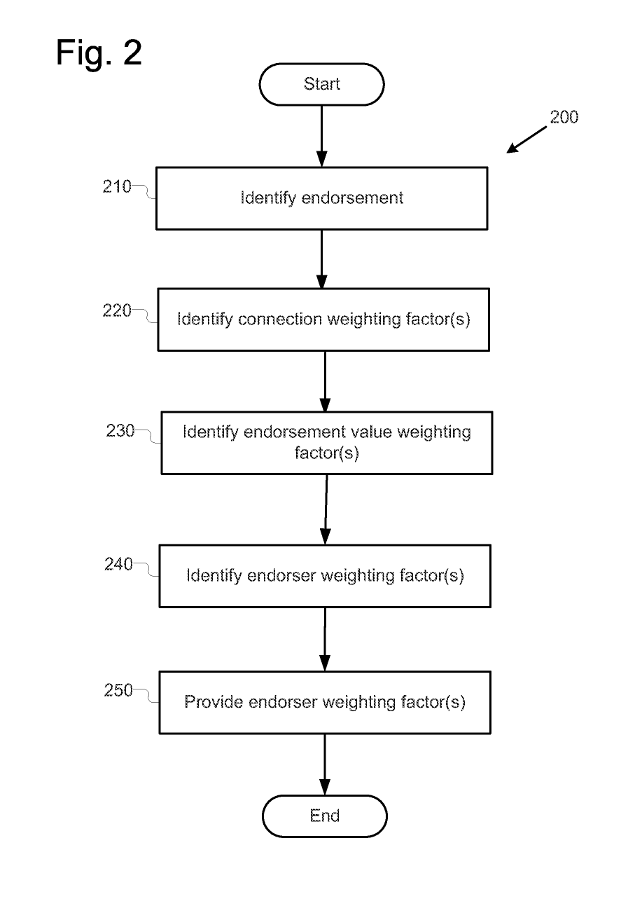

FIG. 2 depicts an example of a process 200 for determining a weighted endorsement of an endorsee by an endorser. As noted above, the endorsee and/or endorser may be an individual person, a group of people, a company, a representative of a company or group, or some other entity that can either receive credit or make an endorsement of another entity. The process may occur, for example, in the endorsement weighting module 165.

Initially, an endorser may make an endorsement of an endorsee, which is identified at 210. For the sake of example, assume that the endorser is the user of the first user equipment 115, and the endorsee is the user of the second user equipment 120. In some cases, the endorsement value may be a simple binary response, e.g. a “like/dislike,” “yes/no,” or some other response indicating whether the endorser believes that the endorsee is a “good” credit investment or a “poor” credit investment. For example, the endorsee may ask the endorser to make an endorsement, and the endorser may either respond positively (“yes”), or negatively (“no” or no response). A “good” credit investment may be an endorsee that is likely to pay the loan back in full, make timely payments, and otherwise exhibit desirable repayment behaviors. A “poor” credit investment may be an endorsee that is unlikely to pay back the loan in full, likely to be consistently late with loan payments, or otherwise exhibit undesirable behaviors.

In some embodiments, the endorsement may be transaction-specific. That is, the endorsement may be based on a specific transaction or value of the credit investment. As an example, a potential endorser may make a different endorsement if the transaction is related to investing a small amount in the endorsee than if the transaction is related to investing a large amount in the endorsee, or vice versa. As another example, the potential endorser may make a different endorsement if the transaction is related to a particular field or cause that the endorser knows that the endorsee has an interest or relation to. For example, the endorser may be less likely to make the endorsement of the endorsee if the transaction is related to the endorsee participating in a frivolous activity. By contrast, the endorser may be more likely to make the endorsement of the endorsee if the transaction is related to the endorsee participating in an activity that benefits a group of people or launches a business. In other embodiments, the endorsement may be non-transaction specific, that is related generally to the endorsee without consideration as to what use the investment relates to. In some embodiments, certain creditworthiness metrics may be based on both transaction-specific or non-transaction specific endorsements, which may be weighted similarly to one another or different from one another.

In other embodiments, the endorsement may be a number on a scale such as a scale of 1-5, 1-10, or some other scale. For example, one number, e.g. 10, may indicate that the endorsee is a “good” credit investment and another number, e.g. 1, may indicate that the endorsee is a “poor” credit investment. In other embodiments, another number, e.g. 5 or 10, indicates that the endorsee is good credit investment, and the other numbers represent gradations on that scale. Other gradations or scales may be used in other embodiments. In some embodiments, the endorsement may comprise multiple numbers.

One or more connection weighting factor(s) may then be identified at 220. In general, the connection weighting factor(s) may be used to weight the endorsement based on how well the endorser and the endorsee know one another. As described above, it may be the case that an endorser who knows an endorsee well may be in a better position to gauge whether the endorsee is a “good” credit investment or a “poor” credit investment. Therefore, the connection weighting factor(s) may be used to weight the endorsement by the endorser, for example by making that endorser's endorsement worth more in the creditworthiness calculation described below. The following are examples of connection weighting factors, some or all of which may be used in different embodiments. However, other embodiments may use additional connection weighting factors, while still other embodiments may use none of the following connection weighting factors:
Depth of Relationship—The depth of relationship factor may be used to indicate how close the endorser and endorsee are to one another. For example, the depth of relationship factor may indicate whether the endorser and endorsee are closely related, for example in a parent-child or sibling relationship, in an extended-family relationship, in a friend relationship, casual acquaintances, or do not know one another. In one embodiment, the depth of relationship factor may be gauged on a scale of 0-10 where 10 indicates that the endorser and endorsee are close family members, and 0 indicates that the endorser and endorsee do not know one another. In this embodiment, the other numbers on the range of 0-10 may be used to indicate further gradations of the endorser/endorsee relationship. In other embodiments, a different scale may be used, e.g. 0-5, or some other numerical scale. In some embodiments, the different relationships may be weighted differently, for example by applying a lower weight to the depth of relationship factor based on a close relationship if it is assumed that the close relationship may lead to a bias which would result in an endorsement that is not appropriate for the endorsee. In other embodiments, the depth of relationship factor may be gauged on a different scale, for example a non-numerical scale, a scale involving negative numbers, or a scale where a close relationship is a low number and a less close relationship is a high number.
Length of Relationship—The length of relationship factor may be used to indicate how long an endorser and endorsee have known one another. For example, if the length of relationship factor is measured on a scale of 0-10, then 10 may indicate that the endorser and endorsee have known one another for a relatively long period of time, e.g. multiple years, while 0 may indicate that the endorser and endorsee just met or do not know one another. The values between 0-10 may be assigned based on different time periods within those two limits. In other embodiments, different scales (e.g. 0-5, etc.) may be used, and in some embodiments the high value (e.g. 10) may be based on measurements in terms of weeks, months, years, decades, or some other measurement which may be based on the specific embodiment of the social network 100. In other embodiments, the length of relationship factor may be gauged on a different scale, for example a non-numerical scale, a scale involving negative numbers, or a scale where a relatively long relationship is a low number and a relatively short relationship is a high number.
Active Communication Factor—The active communication factor may indicate how often the endorser and endorsee communicate with one another, for example via the social network or via some other trackable communication means (e.g. text message, email, telephone, etc.). For example, if the active communication factor is measured on a scale of 0-10, 0 may be indicate that the endorser and endorsee communicate with one another very rarely, while 10 may indicate daily or even hourly communication. The other values between 0 and 10 may indicate weekly, monthly, or yearly communication, or communication on some other scale. In other embodiments, different scales (e.g. 0-5, etc.) may be used. In other embodiments, the active communication factor may be gauged on a different scale, for example a non-numerical scale, a scale involving negative numbers, or a scale where a large amount of communication is a low number and a low amount of communication is a high number.
Similarity Factor—The similarity factor may indicate how similar the endorser and endorsee are to one another. The similarity factor may be based, for example, on whether the endorser and endorsee have the same alma mater, are from the same town, attend the same parties/events, read the same books, listen to the same music, watch the same movies/television, follow the same news articles, or other factors that may be used to identify similarities between the endorser and the endorsee. In embodiments, the similarity factor may be measured on a scale of 0-10 where 10 indicates that the endorser and endorsee have very similar tastes and 0 indicates that the endorser and endorsee have very little in common. The values between 0 and 10 may be used to indicate various gradations of commonality or similarity between the endorser and endorsee. In other embodiments, different scales (e.g. 0-5, etc.) may be used. In other embodiments, the similarity factor may be gauged on a different scale, for example a non-numerical scale, a scale involving negative numbers, or a scale where a high degree of similarities between the endorser and endorsee is a low number and a low degree of similarities is a high number.

Next, one or more endorsement value weighting factor(s) may be identified at 230. In general, the endorsement value weighting factor(s) may be used to weight the strength of the endorsement based on the endorser's past success and participation in the social network 100, i.e. the endorser's endorsement history. For example, an endorser that has more history and has participated actively in the social network 100 may be in a better position to make endorsements of a given endorsee. Additionally, the prediction history weighting factor(s) may assist in reducing the natural bias of friends/family members of the endorsee that may only participate in the social network 100 a single time to provide an endorsement or the endorsee. The following are examples of endorsement value weighting factors, some or all of which may be used in different embodiments. However, other embodiments may use additional endorsement value weighting factors, while still other embodiments may use none of the following endorsement value weighting factors:
Previous Endorsement Factor—The previous endorsement factor may indicate how many endorsements the endorser has made in past interactions with the social network 100. As indicated above, an endorser that has made multiple endorsements in the past may be in a better position to make an accurate prediction of an endorsee. In embodiments, the previous endorsement factor may be rated on a scale of 0-10, where 10 indicates that the endorser has made a high number of endorsements in the past, for example 10 or more endorsements, and 0 indicates that the endorser has made a low number of past endorsements, for example no endorsements. The “high number” and “low number” may be based on the specific implementation of the social network 100. The values between 0 and 10 may be used to rate the number of endorsements between the set high and low number. In other embodiments, different scales (e.g. 0-5, etc.) may be used. In other embodiments, the previous endorsement factor may be gauged on a different scale, for example a non-numerical scale, a scale involving negative numbers, or a scale where several past endorsements is a low value such as 0, and few past endorsements is a high value such as 10.

Previous Success Factor—The previous success factor may be used to indicate how successful a particular endorser has been in the past. For example, if the previous success factor is rated on a scale of 0-10, then 10 may represent that all past endorsees of the endorser have proven to be “good” credit investments. A “good” credit investment may be, for example, someone who has received and fully paid back a loan. 0 may represent that all past endorsees of the endorser have proven to be “bad” credit investments, for example by defaulting on a received loan. The numbers between 0 and 10 may be used to indicate whether different percentages of past endorsees have been “good” or “bad” credit investments. In other embodiments, different scales (e.g. 0-5, etc.) may be used. In other embodiments, the previous success factor may be gauged on a different scale, for example a non-numerical scale, a scale involving negative numbers, or a scale where a high number of “bad” credit investments receives a high value such as 10, and a high number of “good” credit investments receives a low value such as 0.

Endorsee Rating Factor—The endorsee rating factor may be used to indicate whether past endorsees of the endorser have exhibited behaviors of “good” endorsees. A “good” behavior may be based on whether the past endorsees have been timely with loan payments, submitted prepayments, or other similar factors. A “bad” behavior may be based on whether the past endorsees have been consistently late with loan payments, consistently paid the minimum payments, etc. If the endorsee rating is calculated on a scale of 0-10, a value of 10 may indicate that all past endorsees of the endorser have been “good” endorsees, while a value of 0 may indicate that all past endorsees of the endorser have been “bad” endorsees. The values between 0 and 10 may be used to indicate whether different percentages of past endorsees have been “good” or “bad” endorsees. In other embodiments, different scales (e.g. 0-5, etc.) may be used. In other embodiments, the endorsee rating factor may be gauged on a different scale, for example a non-numerical scale, a scale involving negative numbers, or a scale where a high number of “bad” endorsees receives a high value such as 10 and a high number of “good” endorsees receives a low value such as 0.

Commonality Factor—The commonality factor may indicate how similar the endorser is to other successful or un-successful endorsers in the social network 100. The commonality factor may be based, for example, on whether the endorser and other endorsers in the social network 100 have the same alma mater, are from the same town, attend the same parties/events, read the same books, listen to the same music, watch the same movies/television, follow the same news articles, or other factors that may be used to identify similarities or commonalities between the endorser and other endorsees in the social network 100. In embodiments, the commonality factor may be measured on a scale of 0-10 where 10 may indicate that the endorser has very similar tastes to other “successful” endorsers, that is endorsers who have previously endorsed endorsees that were considered “good” credit investments, and 0 may indicate that the endorser has very similar tastes to other “un-successful” endorsers, that is endorsers who have previously endorsed endorsees that were considered “bad” credit investments. In this embodiment, a value of 5 may indicate that the endorser has very little in common with either successful or un-successful endorsers, or alternatively the endorser has several things in common with both successful and un-successful endorsers. The values between 0 and 10 may be used to indicate various gradations of commonality or similarity between the endorser and other successful or un-successful endorsers. In other embodiments, different scales (e.g. 0-5, etc.) may be used. In other embodiments, the similarity factor may be gauged on a different scale, for example a non-numerical scale, a scale involving negative numbers, or a scale where a high degree of similarities or commonalities between the endorser and other successful endorsers is a low number and a high degree of similarities or commonalities between the endorser and other un-successful endorsers is a high number.

Even though the factors described above are described according to a scale of 0-10, different factors may be based on different scales from one another. For example, one weighting factor may be based on a scale of 0-10 while another weighting factor is based on a scale of 0-5 or some other scale. In embodiments, each scale may be normalized such that, for example, a value of 5 on a scale of 0-5 provides a roughly equivalent weighting to a value of 10 on a scale of 0-10, while in other embodiments the scales may not be normalized. Additionally, in some embodiments certain factors may be combined. In other embodiments, other factors may likewise be combined. For example, the previous success factor and endorsee rating factors may be combined in some embodiments. In some embodiments the commonality and similarity factors may be combined. As noted above, other embodiments may have additional or alternative weighting factors.

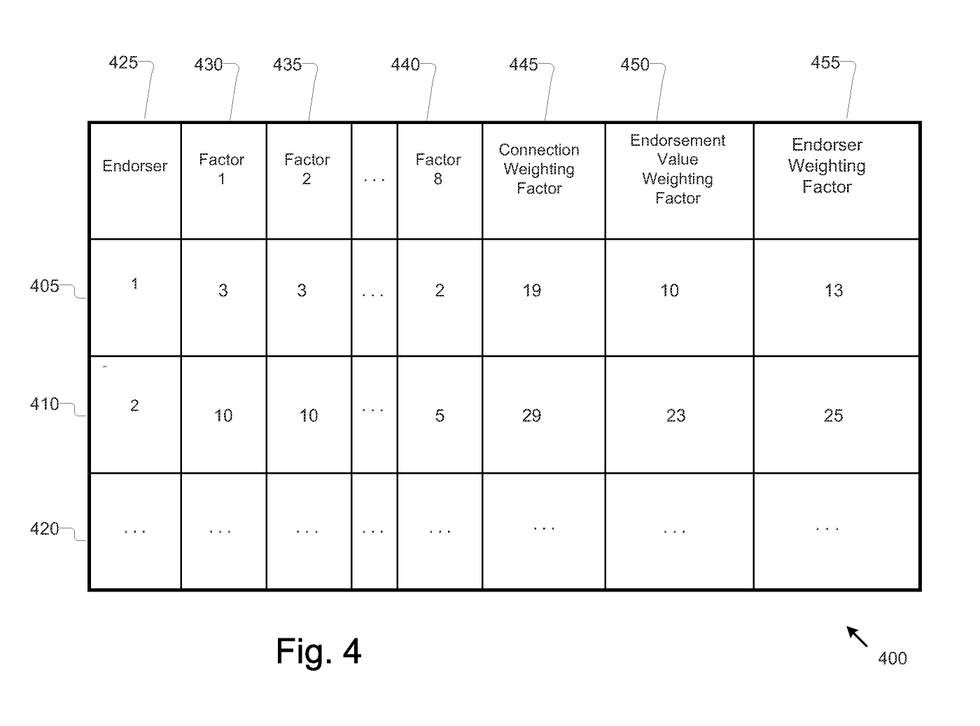

After the identification of the connection weighting factor(s) at 220 and the endorsement value weighting factor(s) at 230, the endorser weighting factor may be identified at 240. The endorser weighting factor may be based on one or both of the connection weighting factor(s) and the endorsement value weighting factor(s). For example, the endorser weighting factor may be a sum, average, product, quotient, mean, median, or some other mathematical combination of one or more of the above described connection or endorsement value weighting factors. In some embodiments the connection weighting factors and the endorsement value weighting factors may be weighted differently from one another when calculating the endorser weighting factor, while in other embodiments they may receive the same weights. In some embodiments, a single endorser weighting factor may be calculated, for example taking into account both the connection and endorsement value weighting factor(s), while in other embodiments multiple endorser weighting factors may be calculated, for example a separate endorser weighting factor for the connection weighting factor(s) and the endorsement value weighting factor(s). One example calculation of an endorser weighting factor is described below with respect to FIG. 4.

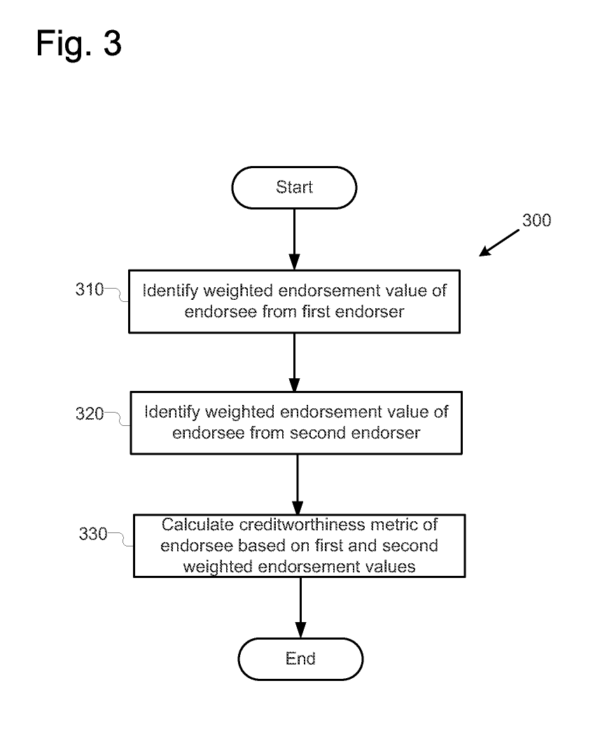

After identifying the endorser weighting factor(s) at 240, the endorser weighting factor(s) identified at 240 may be provided to a credit assessor module, for example credit assessor module 160, at 250. FIG. 3 depicts a process 300 for determining a creditworthiness metric. The process 300 may be performed, for example, by credit assessor module 160. Initially, one or more endorser weighting factor(s) of a first endorsement by a first endorser of an endorsee may be identified at 310. The endorser weighting factor(s) may correspond to one or more endorser weighting factor(s) output by an endorsement weighting module such as endorsement weighting module 165 at 250, above, for the first endorsement.

Next, one or more endorser weighting factor(s) of a second endorsement by a second endorser of an endorsee may be identified at 320. The one or more endorser weighting factor(s) may correspond to one or more endorser weighting factor(s) output by an endorsement weighting module such as endorsement weighting module 165 at 250, above, for the second endorsement.

Next, a creditworthiness metric of the endorsee may be calculated based at least in part on the first and second endorser weighting factors at 330. The creditworthiness metric may be a numerical value on a scale, for example between 0-10, 0-100, or some other scale. In other embodiments, the creditworthiness metric may be a non-numeric value such as “good,” “great,” “average,” “bad,” or some other value or descriptor. In embodiments, the creditworthiness metric may be based on one or more mathematical calculation such as averaging, summing, subtracting, multiplying, dividing, or some other mathematical calculation(s) performed on one or more of the first and second endorser weighting factor(s) identified at 310 and 320. An example calculation of calculating a creditworthiness metric is discussed below with respect to FIG. 4. Although the process 300 is only discussed with respect to two endorsers, in other embodiments the creditworthiness metric may be calculated at 330 based on endorsement(s) and endorser weighting factors from a single endorser, or more than two endorsers.

FIG. 4 depicts an example index 400 which can be used to describe an example calculation of a creditworthiness metric for an endorsee according to various embodiments. Specifically, the index 400 depicts values 405 for a first endorser, values 410 for a second endorser, and entries 420 for further endorsers. Index 400 further depicts columns indicating the endorser 425, a first weighting factor 430, a second weighting factor 435, and an eighth weighting factor 440. Factors 3-7 were not included in the index 400 or the sake of clarity, but will be discussed below. The index 400 then depicts connection weighting metrics at 445, and endorsement value weighting factors at 450. Finally, the index 400 depicts endorser weighting factors at 455.

In embodiments, the endorsement weighting module 165 may first identify a number of weighting factors. For example, the first weighting factor at 430 may correspond to the depth of relationship factor, described above. In this example, the depth of relationship factor may have a value of 3 for the first endorser, which may represent that the first endorser is a casual acquaintance of the endorsee. The depth of relationship factor may have a value of 10 for the second endorser, which may represent that the second endorser is a close family member of the endorsee, for example the endorsee's father.

The second weighting factor at 435 may correspond to the length of relationship factor, described above. In this example, the length of relationship factor may have a value of 3 for the first endorser, which may represent that the first endorser has known the endorsee for a year. The length of relationship factor may have a value of 10 for the second endorser, which may represent that the second endorser has known the endorsee for the endorsee's entire life.

As noted above, the index 400 does not depict factors 3-7 for the sake of clarity, but these factors will be discussed below. For example, the third weighting factor may correspond to the active communication factor, described above. In this example, the active communication factor may have a value of 8 for the first endorser, which may represent that the first endorser and the endorsee are in constant communication, for example because they work together. The active communication factor may have a value of 4 for the second endorser, which may represent that the second endoser and endorsee only speak to one another once every two weeks.

The fourth weighting factor may correspond to the similarity factor, described above. In this example, the similarity factor may have a value of 5 for the first endorser, which may represent that the first endorser and the endorsee tend to read the same books and go to the same restaurants. The similarity factor may also have a value of 5 or the second endorser, which may indicate that the second endorser and the endorsee tend to read the same books and are from the same home town.

The fifth weighting factor may correspond to the previous endorsement factor, described above. In this example, the previous endorsement factor may correspond to a value of 3 for both the first and second endorsers, which may indicate that the first and second endorsers have only made a single previous endorsement. The sixth weighting factor may correspond to the previous success factor, described above. In this example, the previous success factor may have a value of 0 for the first endorser, which may indicate that the first endorser's previous endorsee defaulted on a loan. The previous success factor may have a value of 10 for the second endorser, which may indicate that the second endorser's previous endorsee paid their loan back in full.

The seventh weighting factor may correspond to the endorsee rating factor, described above. In this example, the endorsee rating factor may have a value of 5 for the first endorser, which may indicate that the first endorser's previous endorsee paid installments of their loan in a timely manner, and even made a small number of prepayments, prior to defaulting on their loan. The endorsee rating factor may also have a value of 5 for the second endorse, which may also indicate that the second endorser's previous endorsee made a small number of prepayments and paid installments of their loan in a timely manner. Note that the endorsee rating factor, in this embodiment, is judged separately from the overall determination of whether the endorser's previous endorsee defaulted on their loan. As described above, in other embodiments the endorsee rating factor and the previous success factor may be combined such that the overall determination of whether a previous endorsee paid their loan in full affects the endorsee rating factor. Additionally, in other embodiments the factors may be weighted differently such that prepayments negatively affect the endorsee rating factor and would lower the value of that score.

The eighth weighting factor may correspond to the commonality factor. As depicted at 440, the commonality factor may have a value of 2 for the first endorser, which may indicate that the first endorser has several factors in common with previous endorsers that have not been successful at recommending endorsees. The commonality factor may have a value of 5 for the second endorser, which may indicate that the second endorser does not have anything obviously in common with other previously successful or unsuccessful endorsers.

As described above, the first through fourth weighting factors may correspond to connection weighting factors. The connection weighting factors may be identified at 220 in FIG. 2, as described above. As shown at 445, the sum of the connection weighting factors for the first endorser may be 19. The sum of the connection weighting factors for the second endorser may be 29. Further, as described above, the fifth through eighth weighting factors may correspond to endorsement value weighting factors. The endorsement value weighting factors may be identified at 230 in FIG. 2, as described above. As shown at 450, the sum of the endorsement value weighting factors for the first endorser may be 10. The sum of the endorsement value weighting factors for the second endorser may be 23.

After identifying the connection weighting factors at 220 in FIG. 2, and endorsement value weighting factors at 230 in FIG. 2, as described above, the endorser weighting factor may be calculated at 240 in FIG. 2, as described above by the endorsement weighting module 165. In this example, the endorser weighting factor may be calculated based on the sum of the endorsement value weighting factors and the sum of the connection weighting factors for each endorser. As noted, in some embodiments the endorsement value weighting factors and the connection weighting factors may be weighted evenly, while in some other embodiments the endorsement value weighting factors and the connection weighting factors may be weighted differently from one another. In this example, the connection weighting factor may contribute 33% of the endorser weighting factor, and the endorsement value weighting factors may contribute 66% of the endorser weighting factor. The endorser weighting factor for the first endorser may therefore be calculated as (33%*19)+(66%*10)=13, as shown at 455 in FIG. 4. The endorser weighting factor for the second endorser may be calculated as (33%*29)+(66%*23)=25, as shown at 455 in FIG. 4. Although the endorser weighting factors described above are numerical, in other embodiments the endorser weighting factors may be revised from a numerical scale into a ranking or category type system, for example “very poor,” “poor,” “neutral,” “good,” and “very good.”

The endorser weighting factors may then be transferred from the endorsement weighting module 165 to the credit assessor module 160. The credit assessor module 160 may then determine the creditworthiness metric of the endorsee based on the endorser weighting factors, for example using the process 300 described in FIG. 3. As noted, the endorser weighting factor for the first endorser may be equal to 13, and the endorser weighting factor for the second endorser may be equal to 25. In some embodiments, the creditworthiness metric may be calculated as the average of the two endorser weighting factors, i.e. 19. In other embodiments, the creditworthiness metric may be based on alternative or additional calculations such as a sum, multiple, polynomial, median, mean, or some other calculation. If the endorser weighting factors are non numeric, e.g. based on the ranking or category type system described above, then the credit assessor module may still be able to use averaging or other calculation function. Similarly to the endorser weighting factors, the creditworthiness metric may additionally or alternatively be based on a non-numeric ranking or category type system.

The above example described with respect to FIGS. 2-4 is one example of an embodiment of the present disclosure. In other embodiments, additional or alternative weighting factors, calculation methods, or numbers of endorsers may be used. The examples used for each of the weighting factors above are merely one embodiment, and different values such as “3” or “5” may be based on different criteria than those described above.

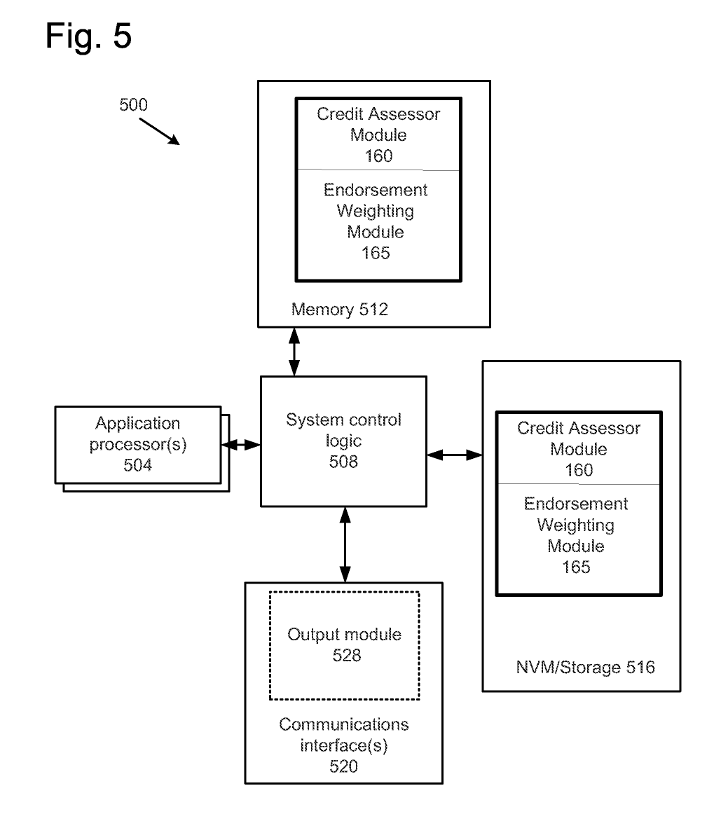

FIG. 5 illustrates, for one embodiment, an example computer system 500 suitable for practicing embodiments of the present disclosure. Computer system 500 may be one or more of server 105, or user equipment 115, 120, or 125. As illustrated, example computer system 500 may include system control logic 508 coupled to at least one of the processor(s) 504, system memory 512 coupled to system control logic 508, non-volatile memory (NVM)/storage 516 coupled to system control logic 508, and one or more communications interface(s) 520 coupled to system control logic 508. In various embodiments, the one or more processors 504 may be a processor core.

System control logic 508 for one embodiment may include any suitable interface controllers to provide for any suitable interface to at least one of the processor(s) 504 and/or to any suitable device or component in communication with system control logic 508.

System control logic 508 for one embodiment may include one or more memory controller(s) to provide an interface to system memory 512. System memory 512 may be used to load and store data and/or instructions, for example, for computer system 500. In one embodiment, system memory 512 may include any suitable volatile memory, such as suitable dynamic random access memory (DRAM), for example.

System control logic 508, in one embodiment, may include one or more input/output (I/O) controller(s) to provide an interface to NVM/storage 516 and communications interface(s) 520.

NVM/storage 516 may be used to store data and/or instructions, for example. NVM/storage 516 may include any suitable non-volatile memory, such as flash memory, for example, and/or may include any suitable non-volatile storage device(s), such as one or more hard disk drive(s) (HDD(s)), one or more solid-state drive(s), one or more compact disc (CD) drive(s), and/or one or more digital versatile disc (DVD) drive(s), for example.

The NVM/storage 516 may include a storage resource physically part of a device on which the computer system 500 is installed or it may be accessible by, but not necessarily a part of, the device. For example, the NVM/storage 516 may be accessed over a network via the communications interface(s) 520.

System memory 512 and NVM/storage 516 may be configured to store, in particular, temporal or persistent copies of credit assessor module 160 and/or endorsement weighting module 165.

Communications interface(s) 520 may provide an interface for computer system 500 to communicate over one or more network(s) and/or with any other suitable device. Communications interface(s) 520 may include any suitable hardware and/or firmware, such as a network adapter, one or more antennas, a wireless interface, and so forth. In various embodiments, communication interface(s) 520 may include an output module 528 for computer system 500 to use NFC, optical communications (e.g. barcodes), BlueTooth or other similar technologies to communicate directly (e.g. without an intermediary) with another device.

In embodiments, modules 160 and 165, system control logic 508, and/or application processor(s) 504 may be configured to, either separately or in combination with one another, perform the processes described above such as processes 200, 300, 400, or 500.

Computer-readable media (including non-transitory computer-readable media), methods, systems and devices for performing the above-described techniques are illustrative examples of embodiments disclosed herein. Additionally, other devices in the above-described interactions may be configured to perform various disclosed techniques.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such elements. Further, ordinal indicators (e.g. first, second or third) for identified elements are used to distinguish between the elements, and do not indicate or imply a required or limited number of such elements, nor do they indicate a particular position or order of such elements unless otherwise specifically stated.

What is claimed is:

1. A computer-implemented method for technologically determining creditworthiness, the method comprising:
identifying, at a computing device, an endorsement by a first user of an online social network of a creditworthiness of a second user of the online social network;
determining or causing to be determined, by the computing device, a creditworthiness metric of the second user of the online social network based at least in part on the endorsement of the first user of the online social network.

2. The method of claim 1, wherein the endorsement is a general, non-transaction specific endorsement.

3. The method of claim 1, wherein the endorsement is a transaction specific endorsement.

4. The method of claim 1, wherein determining or causing to be determined the creditworthiness metric comprises determining or causing to be determined, by the computing device, the creditworthiness metric further based on a connection weighting factor of the endorsement or an endorsement value weighting factor of the endorsement.

5. The method of claim 4, wherein the endorsement value weighting factor is based at least in part on an endorsement history of the first user of the online social network.

6. The method of claim 4, wherein the connection weighting factor is based at least in part on a connection characteristic of a connection between the first user and the second user of the online social network.

7. The method of claim 4, wherein the connection weighting factor is a first portion of the creditworthiness metric, and the endorsement value weighting factor is a second portion of the creditworthiness metric, and the first portion and second portion are different from one another.

8. The method of claim 1, wherein the endorsement is a first endorsement, and the method further comprises identifying, at the computing device, a second endorsement by a third user of the social network of the second user of the social network; and wherein determining or causing to be determined, by the computing device, the creditworthiness metric of the second user further based on the second endorsement of the third user of the online social network.

9. The method of claim 1, wherein the creditworthiness metric is a numerical credit score.

10. A computing apparatus for technologically determining creditworthiness, the apparatus comprising:
one or more processors;
an endorsement weighting module configured to be operated by the one or more processors to:
identify an endorsement by a first user of a social network of a creditworthiness of a second user of the social network;
determine or cause to be determined a creditworthiness metric of the second user of the online social network based at least in part on the endorsement of the first user of the online social network.

11. The apparatus of claim 10, wherein the endorsement is a general, non-transaction specific endorsement.

12. The apparatus of claim 10, wherein the endorsement is a transaction specific endorsement.

13. The apparatus of claim 10, wherein the creditworthiness metric is based at least in part on a connection weighting factor of the endorsement or an endorsement value weighting factor of the endorsement.

14. The apparatus of claim 13, wherein the endorsement value weighting factor is based at least in part on an endorsement history of the first user.

15. The apparatus of claim 13, wherein the connection weighting factor is based at least in part on a connection characteristic of a connection between the first user and the second user of the online social network.

16. The apparatus of claim 13, wherein the connection weighting factor is a first portion of the creditworthiness metric, and the endorsement value weighting factor is a second portion of the creditworthiness metric, and the first portion and second portion are different from one another.

17. The apparatus of claim 10, wherein the endorsement is a first endorsement, and wherein the endorsement weighting module is further configured to:
identify a second endorsement by a third user of the social network of the second user of the social network; and
determine or cause to be determined the creditworthiness metric of the second user further based on the second endorsement of the third user of the online social network.

18. The apparatus of claim 10, wherein the creditworthiness metric is a numerical credit score.

19. One or more computer readable media comprising instruction for technologically determining creditworthiness, the instructions configured to cause a computing device, upon execution of the instructions by the computing device, to:
identify an endorsement by a first user of an online social network of a creditworthiness of a second user of the online social network;
determine or cause to be determined a creditworthiness metric of the second user of the online social network based at least in part on the endorsement of the first user of the online social network.

20. The one or more computer readable media of claim 19, wherein the endorsement is a general, non-transaction specific endorsement.

21. The one or more computer readable media of claim 19, wherein the endorsement is a transaction specific endorsement.

22. The one or more computer readable media of claim 19, wherein the creditworthiness metric is based at least in part on a connection weighting factor of the endorsement or an endorsement value weighting factor of the endorsement.

23. The one or more computer readable media of claim 22, wherein the endorsement value weighting factor is based at least in part on an endorsement history of the first user of the online social network.

24. The one or more computer readable media of claim 22, wherein the connection weighting factor is based at least in part on a connection characteristic of a connection between the first user and the second user of the online social network.

25. The one or more computer readable media of claim 22, wherein the connection weighting factor is a first portion of the creditworthiness metric, and the endorsement value weighting factor is a second portion of the creditworthiness metric, and the first portion and second portion are different from one another.

26. The one or more computer readable media of claim 22, wherein the endorsement is a first endorsement and the creditworthiness metric is a first creditworthiness metric, and the instructions are further configured to cause the computing device to:
identify a second endorsement by a third user of the social network of the second user of the social network; and
determine or cause to be determined a second creditworthiness metric of the second user of the online social network further based on the second endorsement of the third user of the online social network.

27. The one or more computer readable media of claim 19, wherein the creditworthiness metric is a numerical credit score.
